(19) United States
(12) Patent Application Publication
(10) Pub. No.: US 2011/0176305 A1
(43) Pub. Date: Jul. 21, 2011

(54) RADIATION-EMITTING APPARATUS

(75) Inventor: Oskar Schallmoser, Ottobrunn (DE)

(73) Assignee: OSRAM GESELLSCHAFT MIT BESCHRAENKTER HAFTUNG, Muenchen (DE)

(21) Appl. No.: 13/003,012

(22) PCT Filed: Jun. 15, 2009
(86) PCT No.: PCT/EP2009/057373

§ 371 Date: Apr. 7, 2011

(30) Foreign Application Priority Data
Jul. 7, 2008 (DE) 10 2008 031 996.1

(51) Int. Cl. F21V 7/00; G21K 5/00

(52) U.S. Cl. 362/235; 250/503.1

(57) ABSTRACT

A radiation-emitting apparatus for emitting a variable electromagnetic secondary radiation in an emission direction may include at least one radiation-emitting component configured to emit during operation an electromagnetic primary radiation, a reflector, which is arranged in the beam path of the radiation-emitting component and has a first wavelength conversion substance for the at least partial conversion of the primary radiation into electromagnetic conversion radiation, and an aperture, which is variable in terms of its orientation relative to the radiation-emitting component and to the reflector, wherein by way of changing the orientation of the aperture the secondary radiation is variable by changing that proportion of the primary radiation which is emitted by the radiation-emitting component onto the first wavelength conversion substance, and by changing the emitted conversion radiation.

The present invention relates to a radiation-emitting apparatus with a radiation-emitting component according to the preamble to claim 1.

In the case of lighting equipment with a variable color or color temperature, it is possible to combine differently colored individual light sources to form one lamp, wherein the brightness of the individual light sources is adjusted individually, for example, by changing the current. As a result, the resultant heterochromatic color of the lamp is variable. Hereby, however, during normal operation, not all individual light sources are simultaneously illuminated with maximum brightness. In order to obtain a desired quantity of light which can be emitted by the lamp, it is, therefore, necessary to use more individual light sources than are actually needed for the desired quantity of light. Furthermore, a complex electronic management system is required to set the emitted color temperature. This means that a lamp of this kind is complex and cost-intensive.

Also known is lighting equipment with translucent color filter foils through which the light from a light source is radiated and in this way changes its color. However, as a result, light is filtered out and the maximum brightness achievable by the light source is reduced, thus reducing the efficiency of such lighting equipment and hence the manufacturing and operating costs increase.

At least one object of certain embodiments is to disclose a radiation-emitting apparatus for emitting a variable electromagnetic secondary radiation which avoids the drawbacks described above.

This object is achieved by a subject matter with the features of the independent claim 1. Advantageous embodiments and further developments of the subject matter are characterized in the dependent claims and can also be derived from the following description and the drawings.

According to one embodiment, a radiation-emitting apparatus for emitting a variable electromagnetic secondary radiation in an emission direction encompasses in particular
at least one radiation-emitting component, which, during operation, emits an electromagnetic primary radiation,
a reflector, which is arranged in the beam path of the radiation-emitting component and which includes a first wavelength conversion substance for the at least partial conversion of the primary radiation into electromagnetic conversion radiation, and
an aperture, which is variable in terms of its orientation relative to the radiation-emitting component and to the reflector,
   wherein
by way of changing the orientation of the aperture, the secondary radiation is variable by changing that proportion of the primary radiation, which is emitted by the radiation-emitting component onto the first wavelength conversion substance, and by changing the emitted conversion radiation.

Here, and in the following “electromagnetic radiation” in general and “electromagnetic primary radiation”, “electromagnetic secondary radiation” and “electromagnetic conversion radiation” in particular each describe electromagnetic radiation or light with wavelengths from an ultraviolet to infrared wavelength range. Hereby, the conversion radiation and the primary radiation are different from each other. This can in particular mean that the primary radiation includes a first spectral distribution of spectral components, that is individual wavelengths or wavelength ranges with the associated intensities, and the conversion radiation includes a second spectral distribution, wherein the first and the second spectral distribution are different from each other in at least one wavelength. Hereby, in particular, the secondary radiation and the conversion radiation, and furthermore also the primary radiation, may include wavelengths from a visible wavelength range and hence be visible light. Particularly preferably, it is possible to emit such wavelengths and wavelength ranges, which could evoke a monochromatic, heterochromatic or a white, in particular a cold white or a warm white, impression of light in an observer. An impression of the light of an electromagnetic radiation perceivable by an external observer may, for example, be characterized by the chromaticity coordinate in the CIE-1931 standard color chart familiar to the person skilled in the art. A white impression of light may furthermore be characterized by the color temperature and correlated color temperature known to the person skilled in the art.

Here, and in the following, a “change” to an electromagnetic radiation or a proportion of an electromagnetic radiation may in particular mean a change to the intensity, the color, the color temperature or a combination thereof. In particular, with respect to the primary radiation, a change to the proportion of the primary radiation emitted by the radiation-emitting component onto the first wavelength conversion substance may mean a change to the overall radiation power of the primary radiation emitted onto the first wavelength conversion substance. Here and in the following, a change in the conversion radiation may in particular mean a change in the radiation power of the conversion radiation emitted by the radiation-emitting apparatus and/or a change in the spectral composition of the conversion radiation.

Here and in the following, “reflector” denotes an optical component, which, when irradiated with electromagnetic radiation, in turn emits electromagnetic radiation, which can be the same as or different from the irradiated electromagnetic radiation. In the radiation-emitting apparatus described here, in particular primary radiation is irradiated onto the reflector and conversion radiation or conversion radiation together with partially unconverted primary radiation are in turn emitted by the reflector.

Here and in the following, “aperture” denotes an optical component which is suitable for masking electromagnetic radiation out of a solid angle range and hence for shading this solid angle range. The variable orientation of the aperture may also be varied by the shadable solid angle range variable. In particular, an aperture in the sense used here is not transparent and furthermore also not translucent to electromagnetic radiation.

The fact that the aperture can be varied relative to the radiation-emitting component and to the reflector can in particular involve the radiation-emitting component and the reflector being mounted rigidly. This may mean that the radiation-emitting apparatus includes a housing and/or an element for the permanent mounting and/or re-detachable fixation of the radiation-emitting apparatus and the radiation-emitting component and the reflector are attached in or on the housing and/or on the element for the mounting and/or fixation in a fixed and unmovable way. On the other hand, the aperture is variable in terms of its orientation relative to the housing and/or the element for the mounting and/or fixation.

The radiation-emitting apparatus described here may enable the adjustment and adaptation of the emitted secondary radiation, for example, its intensity, color temperature and/or chromaticity coordinate, by a relative change to the orientation of the aperture relative to the radiation-emitting component and to the reflector. Hereby, it may be possible for the radiation-emitting component to be operated continuously and permanently in an unchanged operating mode during the electronic operation of the radiation-emitting apparatus. As a result, the radiation-emitting component may emit an unchanged primary radiation during operation, while the secondary radiation emitted by the radiation-emitting apparatus is still variable. An unchanged operating mode of the radiation-emitting component may hereby mean that the primary radiation is retained unchanged with respect to its intensity and its spectral range. The radiation-emitting component must, therefore, for example not be dimmed. As a result, it may be possible for a complex management system for the electrical supply for the radiation-emitting component as described above to be reduced or omitted entirely for the control of the secondary radiation. It is hence possible for the variability of the secondary radiation to have no influence on the operating mode of the radiation-emitting component, that is, for example on the temperature or electrical parameters such as, for example, the applied voltage or the impressed current.

The secondary radiation may encompass the primary radiation and/or the conversion radiation and may thereby be variable in such a way that at least one of the parameter intensity, color, that is chromaticity coordinate, and color temperature of the secondary radiation is variable. The secondary radiation may hereby, in particular in dependence on the orientation of the aperture relative to the radiation-emitting component and to the reflector, include a proportion of the primary radiation and/or the conversion radiation which is variable by the aperture orientation. The variable proportion of the primary radiation and/or the variable proportion of the conversion radiation of the secondary radiation may each be variable between a maximum value and a minimum value. The maximum and the minimum value of the variable proportion of the primary radiation may hereby be invoked between two specific, different orientations of the aperture. Similarly, the maximum and the minimum value of the proportion of the conversion radiation, which is emitted by the first wavelength conversion substance, are invoked at two specific orientations of the aperture. The minimum value may mean a finite radiation power different from zero for the primary radiation and/or for the conversion radiation or also a radiation power of zero.

This may mean that, in a certain orientation of the aperture, the secondary radiation includes only conversion radiation and no primary radiation and/or in a certain other orientation of the aperture only primary radiation and no conversion radiation. By continuously changing the orientation of the aperture between the two certain orientations of the aperture, it is possible to achieve a continuous changing of the secondary radiation by changing the proportion of the primary radiation and/or the conversion radiation.

Furthermore, depending on the orientation of the aperture relative to the radiation-emitting component and to the reflector, the secondary radiation may include a spectral composition of the conversion radiation which is variable by means of the aperture orientation. The spectral composition of the conversion radiation, that is the entirety of the spectral components of the conversion radiation, may be variable by changing the orientation of the aperture between a first spectrum and a second spectrum variable, wherein the first spectrum and the second spectrum may each be evoked by a certain orientation of the aperture.

For example, the reflector may include a first sub-area with the first wavelength conversion substance and a second sub-area with a second wavelength conversion substance for the conversion of the primary radiation into electromagnetic conversion radiation, wherein the second wavelength conversion substance is different from the first wavelength conversion substance. Hereby, the first and the second sub-area may be directly adjacent to each other. The conversion radiation, which is emitted by the first wavelength conversion substance, may therefore be different from the conversion radiation, which is emitted by the second wavelength conversion substance. By changing the orientation of the aperture relative to the reflector, the ratio of the proportion of the primary radiation, which is irradiated onto the first wavelength conversion substance, and of the proportion of the primary radiation, which is irradiated onto the second wavelength conversion substance, may be variable. As a result, the proportion emitted by the first sub-area and the proportion emitted by the second sub-area of the conversion radiation to the secondary radiation may be variable relative to each other, so that the conversion radiation and hence also the secondary radiation can be variable with respect to their spectral composition.

Furthermore, the reflector may include a plurality of the first sub-areas with the first wavelength conversion substance and a plurality of the second sub-areas with the second wavelength conversion substance. Hereby, the first and second sub-areas can be arranged alternately side by side. Hereby, the first and second sub-areas may be arranged linearly, that is along a straight line or an arc, or along two directions, that is, for example, in the style of a checkerboard or matrix. Furthermore, the arrangement of the first and second sub-areas may be circular or elliptical in the form of segments, sectors, disks or a combination thereof.

The reflector may furthermore be partially reflecting for the primary radiation. This may mean that, without being converted by the first and/or the second wavelength conversion substance, a part of the primary radiation may be diverted by the reflector in the emission direction of the radiation-emitting apparatus. As a result, the electromagnetic radiation emitted by the reflector may give the impression of heterochromatic light from a superimposition of the conversion radiation and the reflected primary radiation. To this end, the reflector may, for example, include a reflecting surface, to which the first or optionally the second wavelength conversion substance is applied. Due to the reflecting surface, unconverted primary radiation, which has traversed the first wavelength conversion substance or optionally the second wavelength conversion substance in unconverted form, may be reflected back into the first or second wavelength conversion substance, so that the conversion probability may be effectively increased as a result.

For example, the reflector or its reflecting surface can be specularly or diffusely reflecting. A specular reflection can, for example, be evoked by a specular surface of the reflector. “Diffusely reflecting” may in particular mean that the primary radiation, which may be irradiated specularly onto the reflector, may be reflected in a non-image forming way and for example isotropically, that is uniformly in different directions, by the reflector. To this end, the reflecting surface may, for example, be roughened or a have a reflecting microstructure.

Alternatively to this, the reflector may be designed so that only conversion radiation is guided and emitted in the emission direction. To this end, the first wavelength conversion substance and/or optionally the second wavelength conversion substance may be embodied so that all the primary radiation irradiated onto the reflector is converted into conversion radiation. Alternatively or additionally, the reflector may include a surface to which the first and/or—if present—the second wavelength conversion substance is applied and which absorbs the primary radiation. Embodiments of this kind may, in particular, be advantageous if the primary radiation encompasses ultraviolet radiation or infrared radiation or is ultraviolet or infrared radiation. Radiation of this kind cannot be perceived by an external observer and may, in the case of ultraviolet radiation, for example, even be undesirable for health reasons.

The reflector may include a plastic, a metal, a ceramic or combinations thereof or be made of one the materials named. For example, the reflector may be made of metal such as, for example, aluminum or silver or at least include a surface made of a metal. Furthermore, the reflector may include a plastic, particularly preferably a white-colored plastic.

Furthermore, the reflector may encompass diffusion particles. Hereby, the diffusion particles may be arranged on the surface of the reflector or they may be included together with the wavelength conversion substance as described above in a matrix material and applied to the reflector. In particular, the diffusion particles may include, for example, a metal oxide, for example a titanium oxide or aluminum oxide such as, for example, corundum, and/or glass particles. Hereby, the diffusion particles may have diameters of grain sizes of less than one micrometer to an order of magnitude of 10 micrometers.

The wavelength conversion substance, that is the first wavelength conversion substance and/or—if present—the second wavelength conversion substance, may include one or more of the following materials: garnets of rare earths alkaline earth metals, for example YAG:Ce³⁺, nitrides, nitride silicates, sions, sialons, aluminates, oxides, halophosphates, orthosilicates, sulfides, vanadates, perylenes, coumarin and chlorosilicates. Furthermore, the wavelength conversion substance may also encompass suitable mixtures and/or combinations thereof.

Furthermore, the wavelength conversion substance may be embedded in a transparent matrix material, which surrounds or contains the wavelength conversion substance or which is chemically bonded to the wavelength conversion substance. The transparent matrix material may include, for example, silicones, epoxides, acrylates, imides, carbonates, olefins or derivatives thereof in the form of monomers, oligomers or polymers as mixtures, copolymers or compounds. For example, the matrix material may be an epoxy resin, polymethyl methacrylate (PMMA) or a silicone resin.

Hereby, the wavelength conversion substance may be homogeneously distributed in the matrix material. Alternatively, different materials from those named above can be distributed and arranged in different layers or regions of the matrix material.

Hereby, the wavelength conversion substance may be applied directly to the reflector. The wavelength conversion substance and/or the matrix material may be applied to the reflector, for example, by a spraying or pressure process, by means of dip-coating, doctoring, painting-on or by means of an electrophoretic process.

The wavelength conversion substance may be suitable to convert the primary radiation into conversion radiation with a higher wavelength. For example, the primary radiation may encompass spectral components in the ultraviolet to green wavelength range, which are converted into conversion radiation with spectral components in the yellow to red wavelength range. Alternatively or additionally, the wavelength conversion substance may also include frequency-mixing and/or frequency-doubling properties, so that, for example, infrared primary radiation is converted into visible conversion radiation.

Furthermore, the aperture may also be at least partially reflecting. Hereby, the aperture may include one or more of the features described above in connection with the reflector. According to the spatial arrangement of the aperture in relationship to the radiation-emitting component and to the reflector described below, the aperture may, therefore, be suitable for diverting the proportion of the primary radiation irradiated onto the aperture in the emission direction or in the direction of the reflector.

As a result of the fact that the orientation of the aperture is variable relative to the radiation-emitting component and to the reflector, the proportion of the primary radiation which is reflected by the at least partially reflecting aperture may also be changed. According to the spatial arrangement of the aperture in relation to the radiation-emitting component and to the reflector, therefore, the proportion of the primary radiation in the secondary radiation or the proportion of the primary radiation diverted or irradiated onto the reflector can be changed, which in turn means the proportion of conversion radiation in the secondary radiation can be changed.

Furthermore, the aperture may include a third wavelength conversion substance for the at least partial conversion of the primary radiation into conversion radiation, which is different from the first and—if present—different from the second wavelength conversion substance. Hereby, the third wavelength conversion substance may include one or more of the features described above in connection with the first and second wavelength conversion substance. Hence, in addition to the primary radiation and/or the conversion radiation emitted by the reflector, the secondary radiation may also include conversion radiation, which is emitted by the aperture.

As a result of the fact that the orientation of the aperture is variable relative to the radiation-emitting component and to the reflector, the proportion of the primary radiation irradiated onto the aperture may be changed. As a result, the proportion of the primary radiation which is converted by the third wavelength conversion substance into conversion radiation, and hence the proportion of the conversion radiation in the secondary radiation, may be changed.

The aperture may have a shape adapted to the shape of the reflector. This may mean that the reflector, for example, has a polygonal or round shape or a combination thereof. To this end, the aperture may have a shape suitable for shading at least a part of or even the whole reflector in at least one orientation of the aperture relative to the reflector. This may in particular mean that the aperture has a similar or the same shape as the reflector. For example, the reflector and the aperture may each have a rectangular, elliptical or circular surface which can be aligned one on top of the other. Geometric surface data relating to the reflector and the aperture may refer to Euclidian or non-Euclidian geometry. This may mean that the area boundary of the reflector and/or the aperture may have a polygonal and/or a round shape and the area bounded thereby is flat in the case of Euclidian geometry or curved in the case of non-Euclidian geometry. For example, the reflector and/or the aperture may be embodied as part of a cylinder jacket, as part of a spherical shell, a rotational ellipsoid, rotational paraboloid or rotational hyperboloid or a combination thereof.

The aperture may in particular be embodied in such a way and be arranged in at least one orientation relative to the radiation-emitting component and to the reflector in such a way that, when viewed by an external observer, the aperture covers at least a part of the reflector. The part of the reflector covered by the aperture may be varied by changing the orientation of the aperture. In particular, this may be perceived by an external observer looking at the aperture and the reflector of the radiation-emitting apparatus against the emission direction.

The aperture may furthermore include at least one opening whose orientation is variable relative to the radiation-emitting component and to the reflector. The opening may, for example, have a shape adapted to the shape of the first wavelength conversion substance and/or—if present—to the shape of the second wavelength conversion substance on the reflector. The first wavelength conversion substance or the first and the second wavelength conversion substances may for example have a polygonal, for example rectangular or quadratic, or a round, for example circular or elliptical surface area on the reflector or a combination thereof. The opening may have a cross section through which, in a certain orientation of the aperture relative to the reflector, the first wavelength conversion substance is fully or almost completely visible from the side of the aperture facing away from the reflector. The opening may therefore have polygonal, for example rectangular or quadratic, or round, for example circular or elliptic, cross section or a combination thereof.

In particular, at least one part of the conversion radiation emitted by the reflector, that is the conversion radiation, which is generated and emitted by the first and/or—if present—by the second wavelength conversion substance may be emitted through the opening in emission direction of the radiation-emitting apparatus.

Furthermore, the aperture may also have a plurality of openings. If, for example, the reflector has, as described above a plurality of first sub-areas with a first wavelength conversion substance and a plurality of second sub-areas with a second wavelength conversion substance arranged alternately side by side, the aperture may have a plurality of openings equal to the plurality in the first and second sub-areas. In a certain orientation of the aperture, in each case, one of the pluralities of openings can be arranged over the plurality of the first sub-areas. As a result, the radiation-emitting apparatus may emit conversion radiation generated and emitted by the first wavelength conversion substance in the first sub-areas through the plurality of the openings. In a further certain orientation of the aperture, in each case one of the plurality of the openings may be arranged over one of the plurality of the second sub-areas. As a result, the radiation-emitting apparatus may emit conversion radiation generated and emitted by the second wavelength conversion substance in the second sub-areas through the plurality of the openings. Changing the orientation of the aperture between these two certain orientations enables the secondary radiation to have variable proportions of the conversion radiation generated by both the first wavelength conversion substance and the second wavelength conversion substance.

The orientation of the aperture may be changed by a translation relative to the radiation-emitting component and to the reflector. This means in particular that the radiation-emitting component and the reflector can be mounted or fixed rigidly, while the aperture may be displaced relative thereto. Hereby, the translation may take place, for example, along a straight line or along a curved line. For example, the translation may also take place on a circular or elliptical translation path. To this end, the radiation-emitting apparatus may include a guide element such as, for example, a guide rail or a sliding mechanism, by means of which the aperture can be displaced mechanically or electromechanically. Translation may encompass or be a continuous displacement or a displacement in discrete steps, for example defined by a raster.

Alternatively or additionally, the secondary radiation can be changed by a rotation of the aperture relative to the radiation-emitting component and to the reflector. This may mean that the aperture is rotatable and the radiation-emitting component and the reflector are mounted rigidly and immovably relative to the environment. The aperture may, for example, be rotatable relative to the reflector about an axis of rotation, which is parallel or perpendicular an extension direction of the reflector. For example, the axis of rotation may be perpendicular to an extension direction of the reflector so that the aperture may be swiveled parallel to the extension direction of the reflector. Furthermore, the aperture may be rotatable relative to the reflector about an axis of rotation which is, for example, parallel to an extension direction of the reflector so that the aperture may be tipped mechanically or electromechanically relative to the reflector. To this end, the radiation-emitting apparatus may include a rotational element such as, for example, a rotating, swiveling or folding mechanism with an axis of rotation such as, for example, a mechanical shaft, a link or a hinge.

A rotation may encompass or be continuous rotation or a rotation in discrete angular steps, for example defined by a raster.

In order to achieve as precise as possible adjustability and variability of the secondary radiation, the radiation-emitting apparatus may in particular include, as described above, a combination of first, second and/or third wavelength conversion substances with a suitable alignment apparatus for the aperture.

In the embodiments described above, the aperture may be arranged between the radiation-emitting component and the reflector. Alternatively, the radiation-emitting component may also be arranged between the aperture and the reflector.

The radiation-emitting component may be embodied as a punctiform, linear or flat radiation source. In particular, hereby, a radiation-emitting component embodied as a punctiform radiation source can preferably be straight, that is parallel to a straight line, but also bent. For example, the radiation-emitting component may encompass a fluorescent lamp, in particular a cold cathode fluorescence lamp (CCFL), a hot cathode fluorescence lamp” (CFL), an external electrode fluorescence lamp” (EEFL) or a flat fluorescence lamp (FFL). Alternatively or additionally, the radiation-emitting component may include or be an electroluminescent foil. Furthermore, the radiation-emitting component may encompass or be a radiation-emitting semiconductor component such as a light-emitting diode or a laser diode. Hereby, the radiation-emitting semiconductor component may be an inorganic or an organic light-emitting diode or laser diode. Hereby, it may also be advantageous for the radiation-emitting apparatus to encompass a plurality of light-emitting diodes or laser diodes, which each emit the same or different electromagnetic radiation.

A radiation-emitting component embodied as an inorganic LED or laser diode may include an epitaxy layer sequence, that is an epitaxially grown semiconductor layer sequence. Hereby, the semiconductor layer sequence may, for example, be embodied on the basis of an inorganic material, for example InGaAlN, such as, for example, GaN thin film semiconductor chips. InGaAlN-based or nitride-based semiconductor chips include, in particular, those in which the epitaxially produced semiconductor layer sequence, which, as a rule, includes a layer sequence of different individual layers, contains at least one individual layer, including a material from the III-V compound semiconductor material system InₓAl_{y}Ga_{i-x-y}N where 0≦x≦1, 0≦y≦1 and x+y≦1. Alternatively or additionally, the semiconductor layer sequence may also be based on InGaA1P, that is it may be phosphide-based, which means that the semiconductor layer sequence includes different individual layers, of which at least one individual layer includes a material made of the III-V compound semiconductor material system InₓAl_{y}Ga_{1-x-y}P where 0≦x≦1, 0≦y≦1 and x+y≦1. Alternatively or additionally, the semiconductor layer sequence may also include other III-V compound semiconductor material systems, for example an AlGaAs-based material, or II-VI compound semiconductor material systems. A II-VI compound semiconductor material system may include at least one element from the second main group, such as, for example Be, Mg, Ca, Sr and an element from the sixth main group, such as, for example O, S, Se. In particular, a II-VI compound semiconductor material system encompasses a binary, ternary or quaternary compound, which encompasses at least one element from the second main group and at least one element from the sixth main group. A binary, ternary or quaternary compound of this kind can also be, for example, one or more dopants and additional components. For example, the II-VI compound semiconductor material systems include the following: ZnO, ZnMgO, CdS, ZnCdS, MgBeO.

The semiconductor layer sequence may include as an active region, for example, a conventional pn junction, a double heterostructure, a single quantum well structure (SQW structure) or a multi-quantum well structure (MQW structure). In addition to the active region, the semiconductor layer sequence can encompass further functional layers and functional regions, for example p- or n-doped charge carrier transport layers, that is electron or hole transport layers, p-, n or undoped confinement or cladding layers, barrier layers, planarization layers, buffer layers, protective layers and/or electrodes and combinations thereof. Such structures relating to the active region or the further functional layers and regions are known to the person skilled in the art, in particular with respect to construction, function and structure and will, therefore, not be described further here.

For example, the radiation-emitting component may emit electromagnetic primary radiation in the ultraviolet spectral range and/or in the blue spectral range. Hereby, the primary radiation may encompass one or more wavelengths in the range of, for example, from 365 nanometers to, for example, 490 nanometers.

With the radiation-emitting apparatus described here, during operation, the radiation-emitting component may be operated unchanged and permanently with optimum efficiency and/or with full brightness, which, with both fluorescent lamps and semiconductor components, may enable high reliability and endurance.

Furthermore, the radiation-emitting apparatus described here may also be suitable, in a switched-off operating mode, for making a variable contribution to the room light or to the color temperature of a room, for example. To this end, the radiation-emitting apparatus may be installed in a room and the first wavelength conversion substance and/or—if present—the second and/or the third wavelength conversion substance may be induced by the ambient light in the room, for example sunlight, for the emission of conversion radiation. By changing the orientation of the aperture relative to the reflector, as described above, in switched-on operating mode of the radiation-emitting apparatus, the conversion radiation may be variable, which means the secondary radiation in the form of the conversion radiation, which may also be emitted in switched-off mode, may be variable.

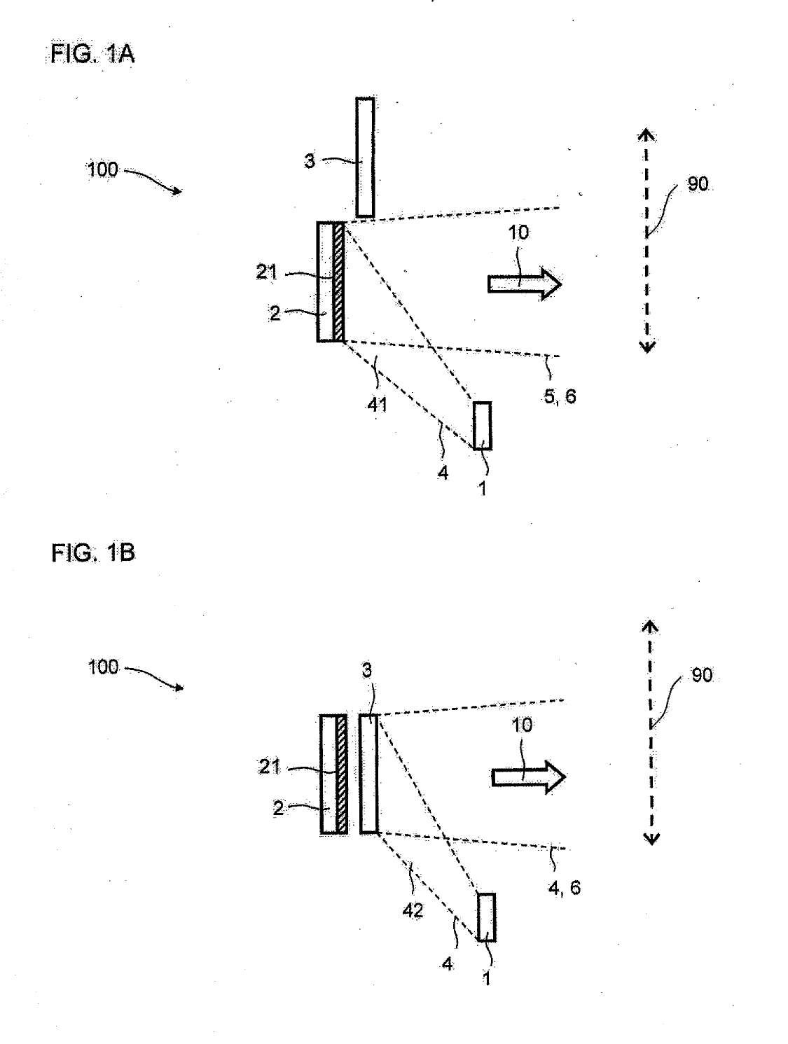

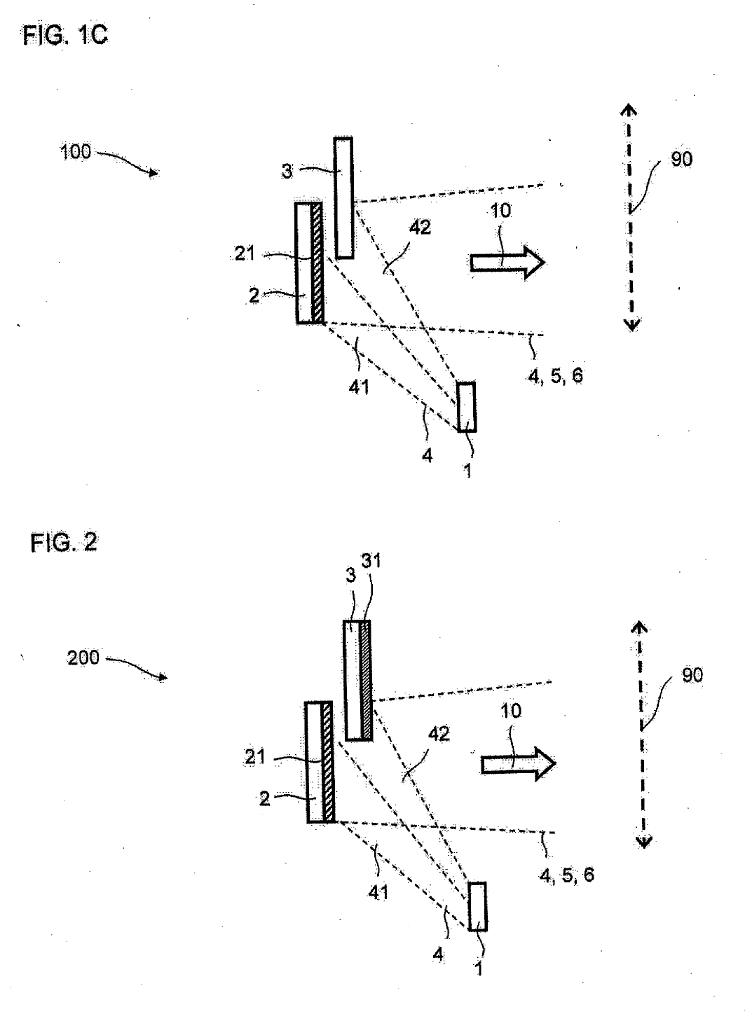

Further advantages and advantageous embodiments and further developments of the invention may be derived from the embodiments described below with reference to FIGS. 1A to 5B, which show:

FIGS. 1A to 1C schematic representations of a radiation-emitting apparatus according to an exemplary embodiment and

FIGS. 2 to 5B schematic representations of radiation-emitting apparatuses according to further exemplary embodiments.

In the exemplary embodiments and figures, the same components or components with the same functions can be identified by the same reference numbers. The elements depicted and their relative sizes should in principle not be treated as true to scale, rather it is possible that individual elements, such as, for example layers, parts, components and regions may be depicted as excessively thick or large for better representability and/or for better understanding.

For reasons of clarity, here and in the following, in the exemplary embodiments the radiation-emitting apparatuses depicted are shown without housings, mechanical holding fixtures, mechanical or electromechanical shifting and/or turning devices and without electric or electronic supply and/or control elements, which are assumed to be known to the person skilled in the art. Common to all exemplary embodiments is the fact that the reflector 2 and the radiation-emitting component(s) 1 is/are rigidly mounted and only the aperture 3 is variable in terms of its orientation relative to the reflector 2 and the radiation-emitting component(s) 1.

FIGS. 1A to 1C show an exemplary embodiment of a radiation-emitting apparatus 100. The radiation-emitting apparatus 100 includes a radiation-emitting component 1, which emits electromagnetic primary radiation 4 during operation. In the exemplary embodiment shown, the radiation-emitting component 1 includes an inorganic, nitride-based laser diode, which emits a primary radiation 4 with a impression of blue light and spectral components with a wavelength in the range of, for example, from 365 to 490 nanometers.

The use of a laser diode in the radiation-emitting component 1 enables the primary radiation 4 to be emitted with a high intensity and with a beam suitable for collimation with low divergence. For applications requiring a high degree of luminosity, the radiation-emitting component 1 may also include a plurality of laser diodes, for example a laser diode bar or a laser diode array. Alternatively, the radiation-emitting component 1 may also include, for example, one or more LEDs or fluorescent lamps. Furthermore, the radiation-emitting component 1 includes a housing and optical components for the collimation of the primary radiation 4, which, as mentioned above, is not shown for purposes of clarity.

The primary radiation 4 is emitted onto a reflector 2. The reflector 2 includes a diffusely reflecting, white surface facing the radiation-emitting component 1. As a result, the reflector 2 is embodied in such a way that, regardless of its wavelength, electromagnetic radiation may be diverted diffusely, that is without a preferred direction, by the reflector. To this end, the reflector 2 is roughened on the surfaces facing the radiation-emitting component 1. Alternatively or additionally, as described above, it is also possible for diffusion particles to be applied to the reflector 2.

Applied to the reflector 2, is a first wavelength conversion substance 21, which can convert the primary radiation, at least partially, into electromagnetic conversion radiation 5. To this end, the first wavelength conversion substance 21 includes one or more of the materials described above in the general part, which are arranged on the reflector 2, embedded in a transparent matrix material. In the exemplary embodiment shown, the conversion radiation 5, which is emitted by the first wavelength conversion substance 21, includes a yellow wavelength. The composition and the concentration of the first wavelength conversion substance 21 and the thickness, with which the first wavelength conversion substance 21 is applied to the reflector 2, are selected in such a way that the primary radiation 4 irradiated onto the reflector 2 is completed converted into conversion radiation 5. Hereby, “completely converted” means that less than 1/e, preferably less than 1/e² and particularly preferably less than 1% of the primary radiation 4 is emitted by the reflector 2 with the first wavelength conversion substance 21, wherein e designates the Euler's number. In particular when the primary radiation 4 includes spectral components from an ultraviolet wavelength range, it is advantageous for reasons of health, for example, for an external observer, for the proportion of the primary radiation 4 emitted by the reflector 2, and hence by the radiation-emitting apparatus 100, to be as low as possible.

Furthermore, the radiation-emitting apparatus 100 includes an aperture 3, which is variable in terms of its orientation relative to the radiation-emitting component 1 and to the reflector 2. In the exemplary embodiment shown, the aperture 3 may be displaced on a translation path or a displacement direction, which is indicated by the double arrow 90, relative to the radiation-emitting component 1 and to the reflector 2. Hereby, the aperture 3 is arranged between the reflector 2 and the radiation-emitting component 1 so that, depending on the relative orientation, the aperture 3 can cover and hence shade at least one part of the reflector 2 from the viewpoint of the radiation-emitting component 1. To change the orientation of the aperture 3, the radiation-emitting apparatus 100 includes a mechanical or electromechanical displacement and/or sliding mechanism such as, for example, a rail, which is not shown for reasons of clarity. Alternatively or additionally, the aperture 3 can also be rotatable relative to the radiation-emitting component 1 and the reflector 3. To this end, the radiation-emitting apparatus 100 may include a swiveling, tilting and/or rotating mechanism, for example in the form an axis of rotation, a hinge and/or a link.

In the exemplary embodiment shown, like the reflector, the aperture includes a diffusely reflecting, white surface facing the radiation-emitting component 1. As a result, regardless of the wavelength, at least the visible proportion of the primary radiation 4, which is irradiated onto the aperture 3, may be reflected diffusely. If the primary radiation 4 includes at least one spectral component from an ultraviolet wavelength range, it can be advantageous furthermore for the aperture 3 to absorb ultraviolet radiation, so that only visible light is reflected by the aperture 3. To this end, the aperture 3 may, for example, include a UV filter layer on the surface facing the radiation-emitting component 1.

In the embodiment shown, the reflector 2 and the aperture 3 have a flat design. Alternatively, the reflector 2 and/or the aperture 3 may also have a curved or bent design. In particular the reflector 2, may for example, also be designed in the form of a concave mirror with specular or diffuse reflection. To this end, the reflector 2 may be embodied in the form of a part of hollow cylinder, a hollow sphere, a rotational ellipsoid, rotational paraboloid, rotational hyperboloid or a combination thereof, wherein the surface of the reflector 2 with the first wavelength conversion substance 21 facing the radiation-emitting component 1 may be embodied in convex or concave form.

During the operation of the radiation-emitting component 1, the radiation-emitting component 1 emits, in the emission direction indicated by the arrow 10, electromagnetic secondary radiation 6, which, depending on the orientation of the aperture 3, is variable relative to the radiation-emitting component 1 and to the reflector 2. FIGS. 1A to 1C show three different orientations of the aperture 3, with reference to which the variability and adjustability of the secondary radiation 6 will be explained below purely by way of example.

In FIG. 1A, the aperture 3 is oriented according to a first orientation in such a way relative to the reflector 2 that the entire primary radiation 4 is irradiated onto the first wavelength conversion substance 21. Hence, in the first alignment, the proportion 41 of the primary radiation 4 which may be converted by the first wavelength conversion substance 21 into conversion radiation 5 encompasses the entire primary radiation 4. Hence, in the first orientation according to FIG. 1A, the radiation-emitting apparatus 100 emits the conversion radiation 5 as secondary radiation 6. Therefore, in the first orientation of the aperture 3, the secondary radiation 6 includes primary radiation 4 with a proportion of zero.

FIG. 1B shows the aperture 3 in a second orientation relative to the reflector 3, in which the aperture 3 completely shades the reflector 2 and hence also the first wavelength conversion substance 21. Hence, the proportion 42 of the primary radiation 4 which is irradiated onto the aperture 3 encompasses the entire primary radiation 4, while the proportion of the primary radiation 4 converted into conversion radiation is equal to zero in the second orientation according to FIG. 1B. As a result, in the second orientation, the radiation-emitting apparatus 100 emits as secondary radiation 6 primary radiation 4 reflected by the aperture 3, which, as described above, in the exemplary embodiment shown, can be the entire visible proportion of the primary radiation 4.

Between the first orientation according to FIG. 1A and the second orientation according to FIG. 1B, the aperture 3 may be continuously changed along the displacement direction 90, as indicated in FIG. 1C. Hence, the aperture 3 may adopt orientations lying between the first and the second orientation. In the orientation of the aperture 3 according to FIG. 1C, the aperture 3 partially shades the reflector 2 and hence the first wavelength conversion substance 21, so that a first proportion 41 of the primary radiation 4 is irradiated onto the first wavelength conversion substance 21 and a further second proportion 42 of the primary radiation 4 onto the aperture 3. Hence, in the orientation of the aperture 3 according to FIG. 1C, the secondary radiation 6 encompasses the variable conversion radiation 5 which may also be varied via the variable first proportion 41, which is emitted by the first wavelength conversion substance 21, and the second proportion 42 of the primary radiation 4, which is reflected by the aperture 3.

Express reference is made to the fact that the proportions 41 and 42 in FIG. 1C are indicated by dotted lines for better understanding only. The first and second proportions 41, 42 of the primary radiation 4 are hereby determined by the design of the radiation-emitting component 1 and in particular the radiation characteristics of the radiation-emitting component 1.

In particular, the conversion radiation 5 emitted by the first wavelength conversion substance 21 and the primary radiation 4 reflected by the aperture 3 may be superimposed at least partially or even congruently, so that the secondary radiation 6 may have homogeneous superimposition and may include a mixture of the primary radiation 4 and the conversion radiation 5.

The secondary radiation 6 is hence variable by changing the first proportion 41 of the primary radiation 4, which is emitted by the radiation-emitting component 1 onto the first wavelength conversion substance 21 and by changing the emitted conversion radiation 5 by way of changing the orientation of the aperture 3. Hereby, in the exemplary embodiment shown, the light impression of the secondary radiation 6 can be varied continuously between blue and yellow. In particular in the orientations of the aperture 3 according to FIG. 1C, between the first orientation according to FIG. 1A and the second orientation according to FIG. 1B, the secondary radiation 6 may evoke a white-colored light impression with a variable color temperature or a variable correlated color temperature by superimposing the blue primary radiation 4 and the yellow conversion radiation 5.

Particularly when using one or more blue LEDs or laser diodes as the radiation-emitting component 1, there is a significant cost advantage for the radiation-emitting apparatus 100 compared to a known illumination system with variable color radiation, since the radiation-emitting component(s) 1 may be operated at full brightness and the color of the light impression of the secondary radiation 6 may still be adjusted by means of the aperture 3. Furthermore, since, even with a plurality of radiation-emitting components 1, only one primary radiation 4 is used, a complex color management system is avoided and hence saved.

The following Figs. show exemplary embodiments of radiation-emitting apparatuses, which encompass modifications and/or extensions of the radiation-emitting apparatus 100 of the exemplary embodiments according to FIGS. 1A to 1C. Therefore, the following description mainly refers to the differences compared to the radiation-emitting apparatus 100.

FIG. 2 shows an exemplary embodiment of a radiation-emitting apparatus 200 representing a modification of the radiation-emitting apparatus 100. Compared to the preceding exemplary embodiment, the radiation-emitting component 1 is designed in such a way that the primary radiation 4 only encompasses blue light with spectral components with a wavelength between, for example, 465 and 480 nanometers.

The reflector 2 and the first wavelength conversion substance 21 are designed in such a way that the first proportion 41 of the primary radiation 4 irradiated onto the reflector 2 and the first wavelength conversion substance 21 is partially converted into conversion radiation 5 with spectral components in a yellow wavelength range and also part of the primary radiation 4 is reflected by the reflector 2. As a result, the reflector 2 emits electromagnetic radiation, which is a superimposition of primary radiation 4 and conversion radiation 5 and is able to evoke an impression of cold-white light in an external observer. Here and in the following, “cold-white” designates electromagnetic radiation with a color temperature or a correlated color temperature of more than, for example, 5500 Kelvin. The color temperature of, for example, 5500 Kelvin hereby corresponds to a black-body radiator with an emission spectrum with color coordinates of x=y=⅓ in the CIE-I 931 standard color chart known to the person skilled in the art.

The aperture 3 includes a third wavelength conversion substance 31 on a surface facing the radiation-emitting component 1, which is suitable for converting the primary radiation 4 at least partially into conversion radiation 5 with spectral components in the green and/or yellow and in the red wavelength range. The third wavelength conversion substance 31 is selected with respect to its material, concentration and thickness on the aperture 3 in such a way that a part of the proportion 42 of the primary radiation 4, which is irradiated onto the aperture 3 and the third wavelength conversion substance 31, may be reflected unconverted by the aperture 3. As a result, the aperture 3 may emit a superimposition of the blue primary radiation 4 and the green and/or yellow and red conversion radiation 5, which evokes an impression of warm-white light in an external observer.

By changing the orientation of the aperture 3 relative to the radiation-emitting component 1 and to the reflector 2, hence the first proportion 41 of the primary radiation, which is irradiated onto the reflector 2 and the first wavelength conversion substance 21, and the second proportion 42 of the primary radiation 4, which is irradiated onto the aperture 3 and the third wavelength conversion substance 31, are changed relative to each other. As a result, the proportion of the electromagnetic radiation with an impression of cold-white light from the reflector 2 and the proportion of the electromagnetic radiation with a warm-white light impression from the aperture 3 may be changed relative to each other. By changing the orientation of the aperture 3, the color temperature or the correlated color temperature the secondary radiation 6, which is emitted by the radiation-emitting apparatus 200 in the emission direction 10, may hence be changed, without the radiation intensity of the radiation-emitting component 1 having to be changed.

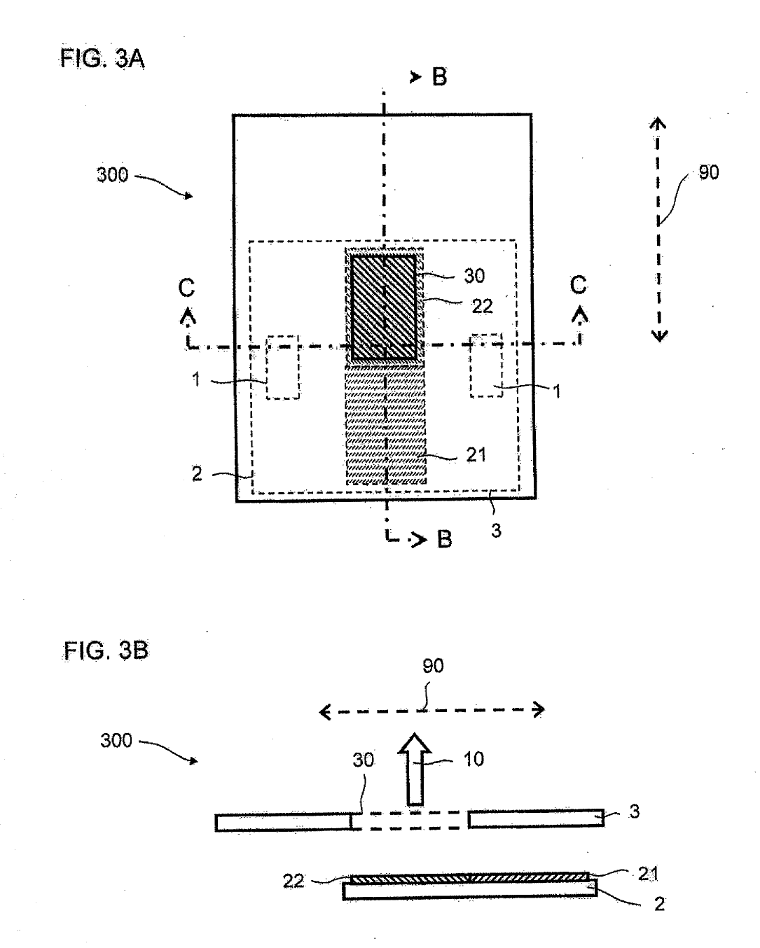

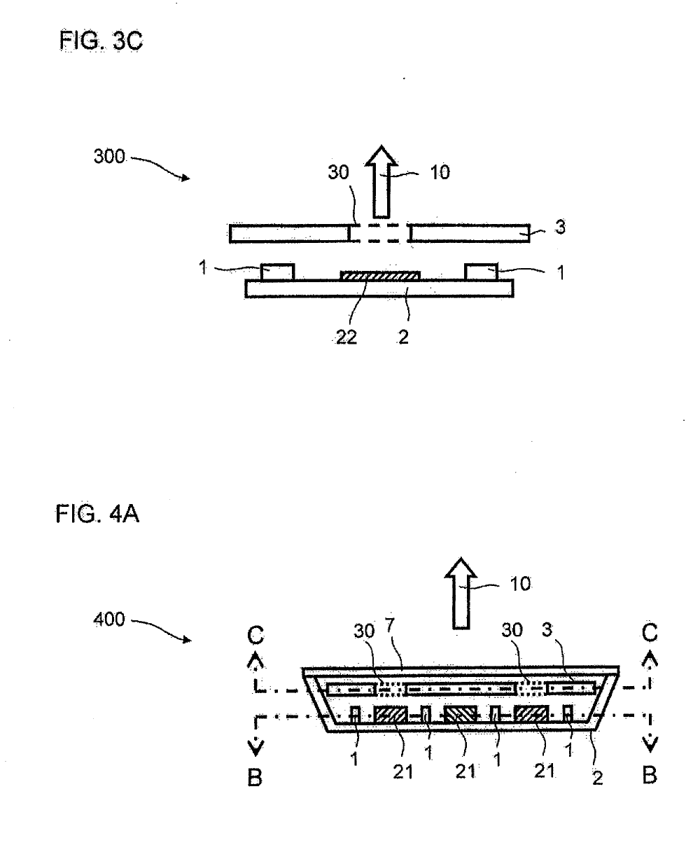

FIGS. 3A to 3C show a further exemplary embodiment of a radiation-emitting apparatus 300. Hereby, FIG. 3A is a top view of the radiation-emitting apparatus 300 against the emission direction 10. FIGS. 3B and 3C show schematic sectional representations along the section planes designed BB and CC in FIG. 3A. The following description refers equally to FIGS. 3A to 3C.

The radiation-emitting apparatus 300 includes a reflector 2, on which a first wavelength conversion substance 21 and, adjacent thereto, a second wavelength conversion substance 22 are arranged. The second wavelength conversion substance 22 is hereby different from the first wavelength conversion substance 21. Furthermore, arranged on the reflector 2 are two radiation-emitting components 1, which are designed as LEDs for emitting blue primary radiation.

Arranged above the reflector 2 is an aperture 3, which reflects the primary radiation, so that primary radiation, which is emitted by the radiation-emitting components 1 in the direction of the reflecting aperture 3, is reflected by this to the wavelength conversion substances 21, 22. The aperture 3 includes an opening 30, which is adapted to the shape of the first and second wavelength conversion substances 21, 22 in such a way that for an external observer, as shown in FIG. 3A, the first and/or the second wavelength conversion substances 21, 22 are visible in a direction of view against the emission direction 10 through the opening 30. In the exemplary embodiment shown, the first and second wavelength conversion substances 21, 22 and the opening 30 each have a rectangular design. In addition, however, other forms, such as, for example described in the general part, are also possible. By changing the orientation of the aperture 3 relative to the reflector 2 and to the radiation-emitting components 1, the opening 30 of the aperture 3 enables the proportion of the primary radiation, irradiated onto the first and the second wavelength conversion substances 21, 22 respectively, to be changed.

In the exemplary embodiment shown, as in the preceding exemplary embodiment, the first wavelength conversion substance 21 is designed in such a way that the blue primary radiation is converted into conversion radiation with spectral components in the yellow wavelength range. The second wavelength conversion substance 22 is designed like the third wavelength conversion substance 31 in the preceding exemplary embodiment in such a way that the blue primary radiation is converted into conversion radiation with spectral components in the green and/or yellow and in the red wavelength range. Since a part of the reflector 2 is free of the first and second wavelength conversion substance 21, 22, at least in this part, the primary radiation can be reflected unconverted.

The aperture 3 is displaceable along the translation path 90 relative to the reflector 2 and the radiation-emitting components 1. In the exemplary orientation of the aperture 3 shown in FIG. 3A, the opening 30 is only arranged over the second wavelength conversion substance 22. As a result, mainly the conversion radiation emitted by the second wavelength conversion substance 22 and unconverted primary radiation are emitted through the opening 30, so that the radiation-emitting apparatus 300 may emit a secondary radiation with an impression of warm-white light in the emission direction 10. If the orientation of the aperture 3 is changed in such a way that the opening 30 is only arranged over the first wavelength conversion substance 21, mainly the conversion radiation emitted by the first wavelength conversion substance 21 and unconverted primary radiation are emitted through the opening 30. In this orientation of the aperture 3 relative to the reflector 2, the radiation-emitting apparatus 300 may emit secondary radiation with an impression of cold-white light. If the opening 30 is arranged in such a way over the first and second wavelength conversion substances 21, 22 that both a part of the first and a part of the second wavelength conversion substance 21, 22 are visible through the opening, the radiation-emitting apparatus 300 can emit secondary radiation, which is a superimposition of electromagnetic radiation with a cold-white and a warm-white light impression.

By continuously changing the orientation of the aperture 3 and hence of the opening 30 relative to the reflector 2 and the radiation-emitting components 1, the secondary radiation may therefore be changed continuously with respect to its light impression, without it being necessary to change the radiation intensity of the radiation-emitting components 1. Furthermore, similar radiation-emitting components 1 are used, which emit the same or at least a similar primary radiation.

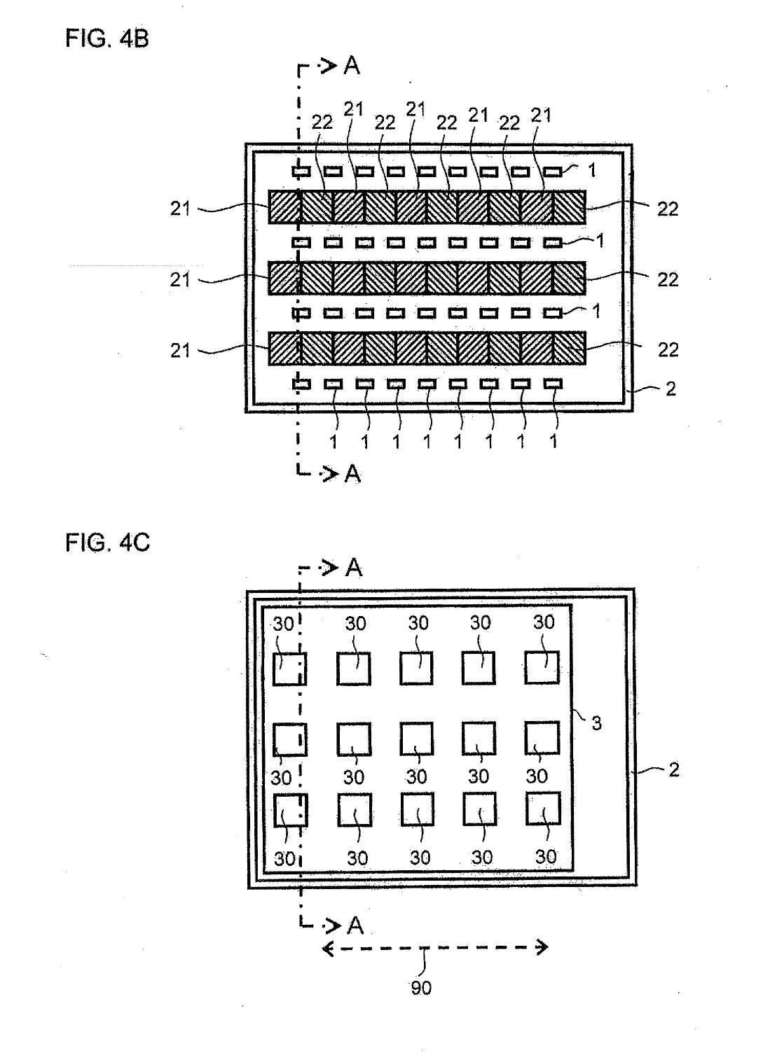

FIGS. 4A to 4C show an exemplary embodiment of a radiation-emitting apparatus 400. FIGS. 4B and 4C show a schematic section representation along the section planes designated BB and CC in FIG. 4A. In FIGS. 4B and 4C, the section plane AA characterizes the section through the radiation-emitting apparatus 400 depicted in FIG. 4A.

Hereby, the radiation-emitting apparatus 400 is designed similarly to the radiation-emitting apparatus 300 in the preceding exemplary embodiment. Unlike the radiation-emitting apparatus 300, however, the radiation-emitting apparatus 400 includes a reflector 2 designed as a light box, in which a plurality of first wavelength conversion substances 21 and a plurality of second wavelength conversion substances 22 are arranged in first and second sub-areas of the reflector 2. The first and second sub-areas with the first and the second wavelength conversion substances 21, 22 are hereby applied along parallel straight lines alternately next to each other on the reflector 2.

Furthermore, arranged on the reflector 2 along parallel straight lines, that is in a honeycomb shape, are respective pluralities of radiation-emitting components 1, designed as LEDs or laser diodes. Alternatively or additionally, radiation-emitting components 1 can also be designed as fluorescent lamps, as described in the general part.

Arranged above the radiation-emitting components 1 and the sub-areas with the first and second wavelength conversion substances 21, 22 is a displaceable, reflecting aperture 3 including a plurality of openings 30. Hereby, each of the openings 30 is allocated to a pair of adjacent first and second wavelength conversion substances 21, 22, so that the secondary radiation emitted by the radiation-emitting apparatus 400 may be changed according to the same principle as in the case of the radiation-emitting apparatus 300 according to FIGS. 3A to 3C.

Arranged above the aperture 3 in the emission direction 10 is a diffuser 7, which permits thorough mixing of the electromagnetic radiation emitted through the openings 30 and hence ensures homogeneous emission of the secondary radiation. Hereby, the diffuser 7 is designed as a diffuser plate with a translucent, that is permitting the passage of light but not transparent, surface in the form of an opal glass pane.

Furthermore, a radiation-emitting apparatus may also include a plurality of first wavelength conversion substances 21 and radiation-emitting components 1 and enable variability of the secondary radiation according to the principle of the radiation-emitting apparatuses 100 and 200 according to FIGS. 1A to 1C or 2.

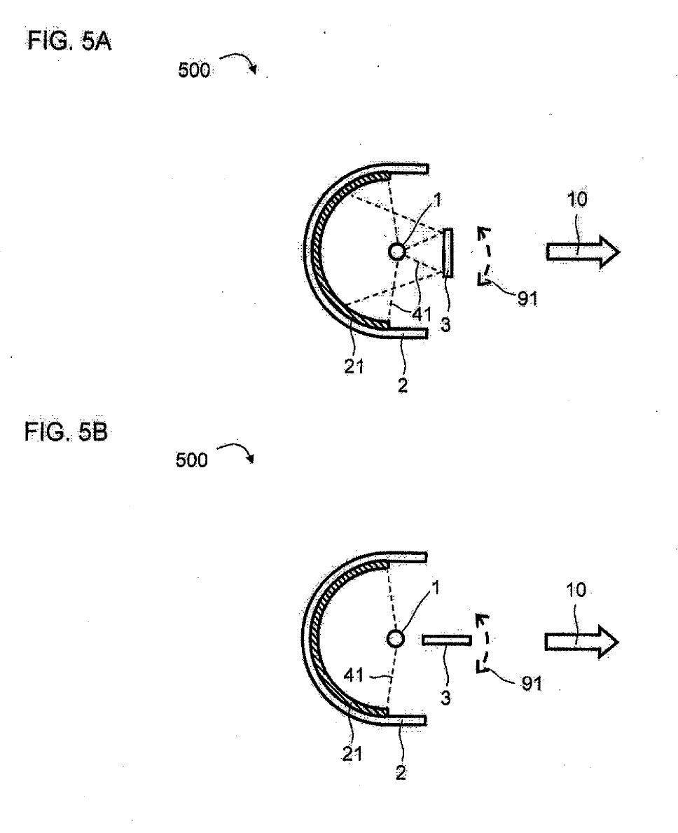

FIGS. 5A and 5B show an exemplary embodiment of a radiation-emitting apparatus 500 including a curved reflector 2. Arranged on the concave surface of the reflector 2 facing a radiation-emitting component 1 is a first wavelength conversion substance 21, which can convert the primary radiation at least partially into electromagnetic conversion radiation. The radiation-emitting component 1 includes in the exemplary embodiment shown a fluorescent lamp, which in the drawing plane is able to emit a primary radiation isotropically. Alternatively, the radiation-emitting component 1 may also be designed as a radial emitting LED or LED array. As in the preceding exemplary embodiments, the radiation-emitting component 1 of the radiation-emitting apparatus 500 emits electromagnetic primary radiation with a impression of blue light, while the first wavelength conversion substance 21 may emit conversion radiation with an impression of yellow or yellowish-red light impression.

The radiation-emitting component 1 is arranged between the reflector 2 and an aperture 3. The aperture 3 is directly reflecting and is, as indicated by the double arrow 90, rotatable in the drawing plane. For purposes of clarity, FIGS. 5A and 5B only show the proportion 41 of the primary radiation, which is irradiated directly or by reflection on the aperture 3 onto the first wavelength conversion substance 21.

The proportion 41 of the primary radiation, which is not irradiated onto the first wavelength conversion substance 21 can be directly emitted in the emission direction 10 (not shown). The secondary radiation emitted by the radiation-emitting apparatus 500 is hence made up of the directly emitted proportion of the primary radiation and the conversion radiation emitted by the first wavelength conversion substance 21. By rotating the aperture 3 relative to the radiation-emitting component 1 and to the reflector 2, that is by changing the orientation of the aperture 3 relative to the radiation-emitting component 1 and to the reflector 2, as shown in FIGS. 5A and 5B, the proportion 41 of the primary radiation, which is radiated onto the first wavelength conversion substance 21, can be changed. As a result, the conversion radiation and also the proportion of the primary radiation, which can be emitted directly in the emission direction 10, can be changed by changing the relative orientation of the aperture 3.

Hence, by rotating the aperture 3, the proportion of the blue primary radiation and the proportion of the yellow conversion radiation in the secondary radiation can be changed. As a result, the light impression of the secondary radiation may be changed between a more bluish light impression in the orientation of the aperture according to FIG. 5B and a more yellowish or yellowish-more-reddish light impression in the orientation of the aperture 3 according to FIG. 5A.

Alternatively to the direct reflecting aperture 3, this may also have a third wavelength conversion substance on the surface facing the reflector in FIG. 5A, as in FIG. 2. The conversion radiation generated by the third wavelength conversion substance radiated back to the reflector 2 by the aperture 3, can be reflected in the emission direction 10 at the reflector 2 in the emission direction and hence contribute to the secondary radiation and its light impression depending upon the orientation of the aperture.

Alternatively or additionally, to a rotatable aperture 3, the radiation-emitting apparatus 500 may also include a displaceable or a rotatable and displaceable aperture.

The combinations of wavelength ranges for the primary radiation and the conversion radiation described in connection with FIGS. 1A to 5B are purely exemplary. In addition, other combinations of wavelength ranges are also possible, which permit secondary radiation with a variable white and/or heterochromatic light impression.

The description with reference to the exemplary embodiments does not restrict the invention these embodiments. Instead, the invention encompasses every new feature and every combination of features, which in particular includes any combination of features in the claims, even if this feature or this combination is not actually explicitly disclosed in the claims or exemplary embodiments.

### LIST OF REFERENCE NUMBERS

1 Radiation-emitting component (1)

2 Reflector

3 Aperture

4 Primary radiation

5 Conversion radiation

6 Secondary radiation

7 Diffuser

10 Emission direction

21 First wavelength conversion substance

22 Second wavelength conversion substance

30 Opening

31 Third wavelength conversion substance

41, 42 Proportion of the primary radiation

90 Translation

91 Rotation

100 Radiation-emitting apparatus

200 Radiation-emitting apparatus

300 Radiation-emitting apparatus

400 Radiation-emitting apparatus

500 Radiation-emitting apparatus

1. A radiation-emitting apparatus for emitting a variable electromagnetic secondary radiation in an emission direction, the apparatus comprising:
at least one radiation-emitting component configured to emit during operation an electromagnetic primary radiation,
a reflector, which is arranged in the beam path of the radiation-emitting component and has a first wavelength conversion substance for the at least partial conversion of the primary radiation into electromagnetic conversion radiation, and
an aperture, which is variable in terms of its orientation relative to the radiation-emitting component and to the reflector,
wherein
by way of changing the orientation of the aperture the secondary radiation is variable by changing that proportion of the primary radiation which is emitted by the radiation-emitting component onto the first wavelength conversion substance, and by changing the emitted conversion radiation.

2. The apparatus according to claim 1, wherein
the reflector comprises a first sub-area with the first wavelength conversion substance and a second sub-area with a second wavelength conversion substance, different from different from the first wavelength conversion substance, for the conversion of the primary radiation into electromagnetic conversion radiation and
by changing the orientation of the aperture, the proportion emitted by the first sub-area and the proportion emitted by the second sub-area of the conversion radiation in the secondary radiation are variable relative to each other.

3. The apparatus as claimed in claim 2, wherein
the reflector comprises a plurality of first sub-areas and second sub-areas arranged alternately side by side.

4. The apparatus as claimed in claim 1, wherein
the reflector is partially reflecting for the primary radiation.

5. The apparatus as claimed in claim 1, wherein
the aperture is at least partially reflecting.

6. The apparatus as claimed in claim 1, wherein
the aperture comprises a third wavelength conversion substance and
by changing the orientation of the aperture, the proportion of the primary radiation, which is emitted by the radiation-emitting component onto the third wavelength conversion substance, is variable.

7. The apparatus as claimed in claim 1, wherein
the aperture comprises at least one opening.

8. The apparatus as claimed in claim 7, wherein
at least one part of the conversion radiation is emitted through the opening by the radiation-emitting apparatus.

9. The apparatus as claimed in claim 7, wherein the aperture comprises a plurality of openings.

10. The apparatus as claimed in claim 1, wherein
the orientation of the aperture relative to the radiation-emitting component is variable by at least one of a translation and a rotation.

11. The apparatus as claimed in claim 1, wherein
the aperture, viewed by an external observer covers at least a part of the reflector, which is variable by changing the arrangement of the aperture.

12. The apparatus as claimed in claim 1, wherein
the aperture is arranged between the radiation-emitting component and the reflector.

13. The apparatus as claimed in claim 1, wherein
the radiation-emitting component is arranged between the reflector and the aperture.

14. The apparatus as claimed in claim 1, wherein
the radiation-emitting component comprises at least one of a radiation-emitting semiconductor component and a fluorescent lamp.
